(19) United States
(12) Patent Application Publication
(10) Pub. No.: US 2025/0290481 A1
(43) Pub. Date: Sep. 18, 2025

(54) INJECTION ASSEMBLY, BEARING ASSEMBLY, AND FUEL INJECTOR

(71) Applicant: CUMMINS INC., Columbus, IN (US)

(72) Inventors: Dominic Robert Dillon Brown, Stockton on Tees (GB); Zbigniew Grzegorz Krawiec, Darlington (GB); Philippe Charles Spozio, Great Ayton (GB); Neha Verma, Balewadi (IN)

(73) Assignee: CUMMINS INC., Columbus, IN (US)

(21) Appl. No.: 19/067,483

(22) Filed: Feb. 28, 2025

(30) Foreign Application Priority Data
Mar. 13, 2024 (GB) 2403607.1

(51) Int. Cl. F02M 63/00

(52) U.S. Cl. CPC F02M 63/0015; F02M 2200/16

(57) ABSTRACT

A fuel injector includes an injection assembly and a bearing assembly. The injection assembly includes an injection housing that includes a housing sealing surface defining a cavity, and an injection body disposed at least partially within the injection housing. The injection body includes a plunger that includes a plunger sealing surface that interfaces with the housing sealing surface to create a fuel-tight seal, and an extension member coupled to the plunger and translates the plunger in an axial direction. The bearing assembly includes a bearing housing and an outer bearing coupled to and disposed within the bearing housing. The outer bearing and the bearing housing define a plurality of bearing channels. The bearing assembly further includes an inner bearing disposed at least partially within the outer bearing and slidably coupled to the outer bearing, and a support shaft coupled to the inner bearing and translates in an axial direction.

### CROSS-REFERENCE TO RELATED APPLICATIONS

This application claims priority to and the benefit of United Kingdom Patent Application No. 2403607.1, filed Mar. 13, 2024, the content of which is incorporated by reference in its entirety.

### TECHNICAL FIELD

The present application relates generally to fuel injectors for use in internal combustion engine systems.

### BACKGROUND

Internal combustion engine systems can include fuel injectors that inject fuel into combustion chambers of internal combustion engines. Each of the fuel injectors can correspond to one of the cylinders.

### SUMMARY

In one embodiment, an injection assembly for a fuel injector includes an injection housing that includes a housing sealing surface defining a cavity that receives fuel. The injection assembly further includes an injection body disposed at least partially within the injection housing. The injection body includes a plunger that includes a plunger sealing surface that interfaces with the housing sealing surface to create a fuel-tight seal. The injection body further includes an extension member coupled to the plunger. The extension member translates the plunger in an axial direction.

In another embodiment, a bearing assembly for a fuel injector includes a bearing housing and an outer bearing coupled to and disposed within the bearing housing. The outer bearing and the bearing housing define a plurality of bearing channels that receive fuel. The bearing assembly further includes an inner bearing disposed at least partially within the outer bearing and slidably coupled to the outer bearing. The bearing assembly further includes a support shaft coupled to the inner bearing. The support shaft translates in an axial direction.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is cross-sectional view of a fuel injector according to an example embodiment;

FIG. 2 is a view of Detail A in FIG. 1;

FIGS. 3 and 4 are partial views of Detail A in FIG. 1;

FIG. 5 is a view of Detail B in FIG. 1;

FIGS. 6 and 7 are partial views of Detail B in FIG. 1;

FIG. 8 is a view of Detail C in FIG. 1;

FIGS. 9 and 10 are partial views of Detail C in FIG. 1;

FIG. 11 is a view of Detail D in FIG. 1; and

FIGS. 12-15 are partial views of Detail D in FIG. 1.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and systems for a fuel injector. The various concepts introduced above and discussed in greater detail below can be implemented in any of a number of ways, as the described concepts are not limited to any particular manner of implementation. Examples of specific implementations and applications are provided primarily for illustrative purposes.

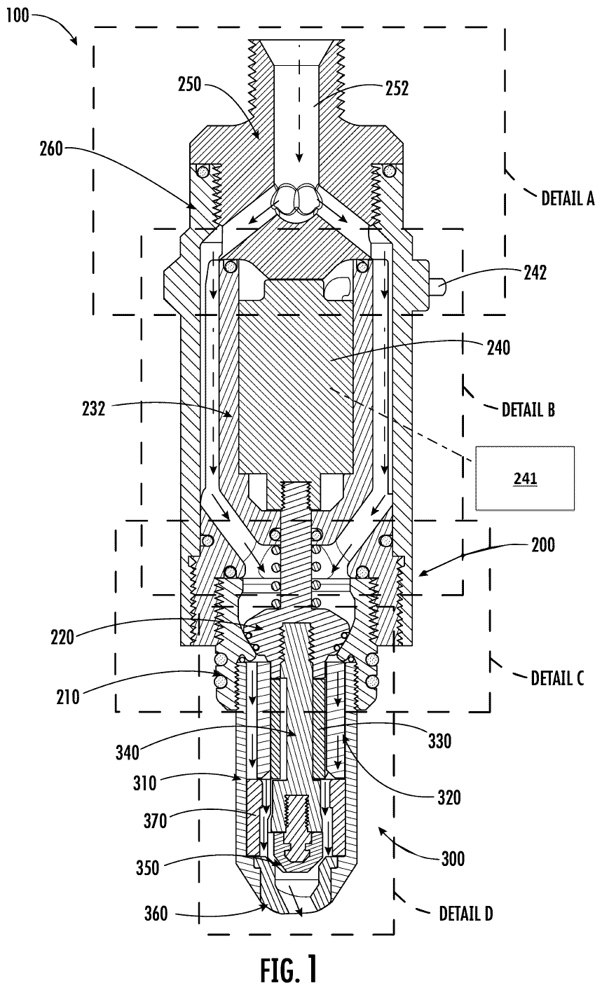

FIG. 1 illustrates a fuel injector 100. The fuel injector 100 can be part of an engine system that includes an engine (e.g., an internal combustion engine), such as a spark-ignition engine or a compression-ignition engine. Examples of the engine include a hydrogen engine, a diesel engine, a gasoline engine, a propane engine, a dual-fuel engine, a natural gas engine, etc. The engine is configured to combust at least one fuel (e.g., hydrogen, diesel, gasoline, propane, natural gas, etc., or a combination of fuels) to produce energy that can be utilized by various outputs. For example, the engine can produce energy that is utilized to drive a movement member (e.g., wheel, tread, propeller, impeller, turbine, rotor, etc.) or power a generator. The engine can be implemented in a vehicle (e.g., truck, car, construction vehicle, freight vehicle, commercial vehicle, emergency vehicle, military vehicle, maritime vehicle, etc.).

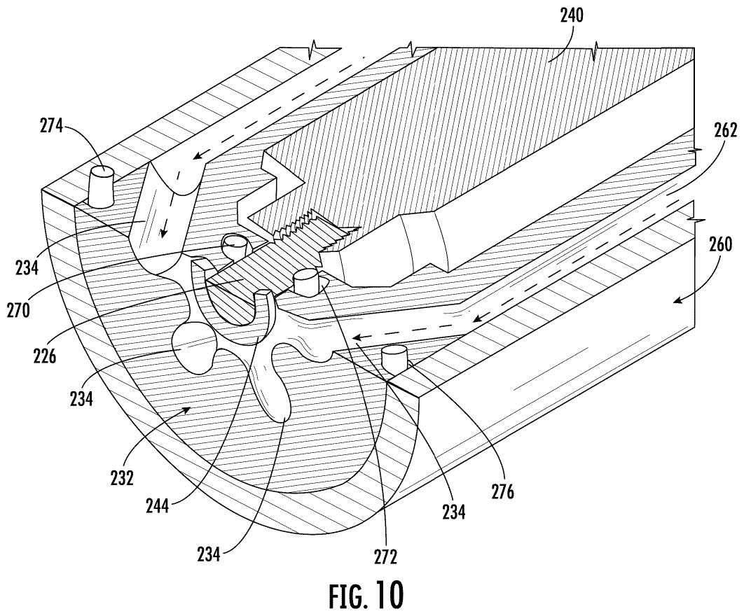

The fuel injector 100 can include an injection assembly 200. As illustrated in FIGS. 1 and 8-10, the injection assembly 200 for the fuel injector 100 comprises an injection housing 210 comprising a housing sealing surface 212 defining a cavity 214 configured to receive fuel. The injection assembly 200 further comprises an injection body 220 disposed at least partially within the injection housing 210. The injection body 220 comprises a plunger 222 comprising a plunger sealing surface 224 configured to interface with the housing sealing surface 212 to create a fuel-tight seal. The injection body 220 further comprises an extension member 226 coupled to the plunger 222. The extension member 226 is configured to translate the plunger 222 in an axial direction.

In some embodiments, the extension member 226 and the plunger are monolithic. In other embodiments, the extension member 226 is coupled to the plunger 222 via interfacing threads (e.g., inner threads of the extension member 226 interface with outer threads of the plunger 222, outer threads of the extension member 226 interface with inner threads of the plunger 222, etc.), welding, adhesive, fasteners, or the like.

The fuel injector 100 can include a plunger sealing member 228 (e.g., a gasket, a pressed gasket, a paper gasket, etc.) coupled to the plunger sealing surface 224. The plunger sealing member 228 is configured to engage with the housing sealing surface 212 and create, or enhance, the fuel-tight seal between the plunger sealing surface 224 and the housing sealing surface 212 to prevent or minimize transfer of fluid between the plunger sealing surface 224 and the housing sealing surface 212 to downstream of the plunger sealing member 228. The fuel-tight seal can be a liquid fuel-tight seal and/or a gas fuel-tight seal.

The plunger sealing member 228 can be formed of or otherwise include a polymer, such as nitrile rubber or polyetheretherketone (e.g., PEEK). The plunger 222 can define a groove 230 proximate the plunger sealing surface 224. The plunger sealing member 228 can be disposed within the groove 230 of the plunger 222. The plunger sealing member 228 can include an O-ring. The fuel injector 100 can include a plurality of the plunger sealing member 228 and the groove 230, where each of the plunger sealing members 228 corresponds to each of the grooves 230. For example, the fuel injector 100 can include two, three, six, etc. of the plunger sealing member 228 and the groove 230.

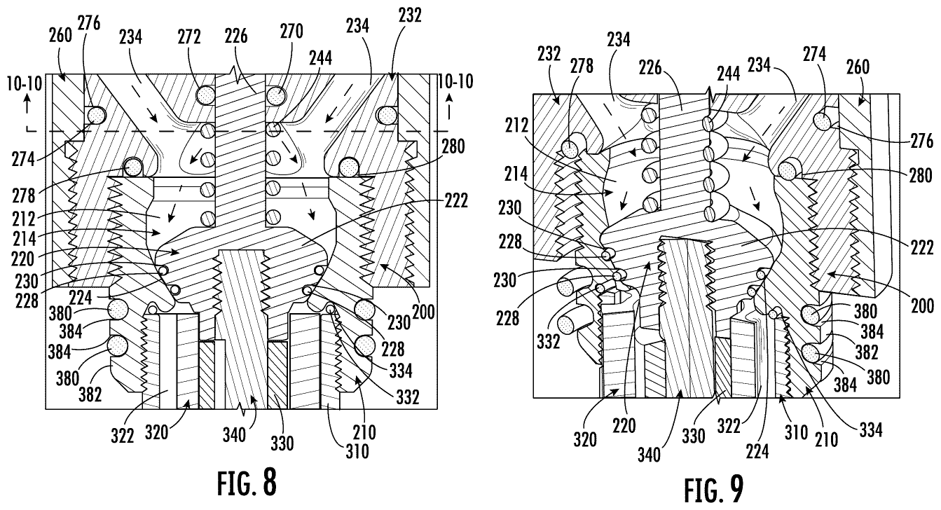

As illustrated in FIGS. 8 and 9, the fuel injector 100 can include an inner housing 232. The inner housing 232 can be coupled to the injection housing 210. In some embodiments, the inner housing 232 is coupled to the injection housing 210 via interfacing threads, thereby simplifying a disassembly process between the inner housing 232 and the injection housing 210 for maintenance or component replacements. In other embodiments, the inner housing 232 is coupled to the injection housing 210 via welding, adhesive, fasteners, or the like.

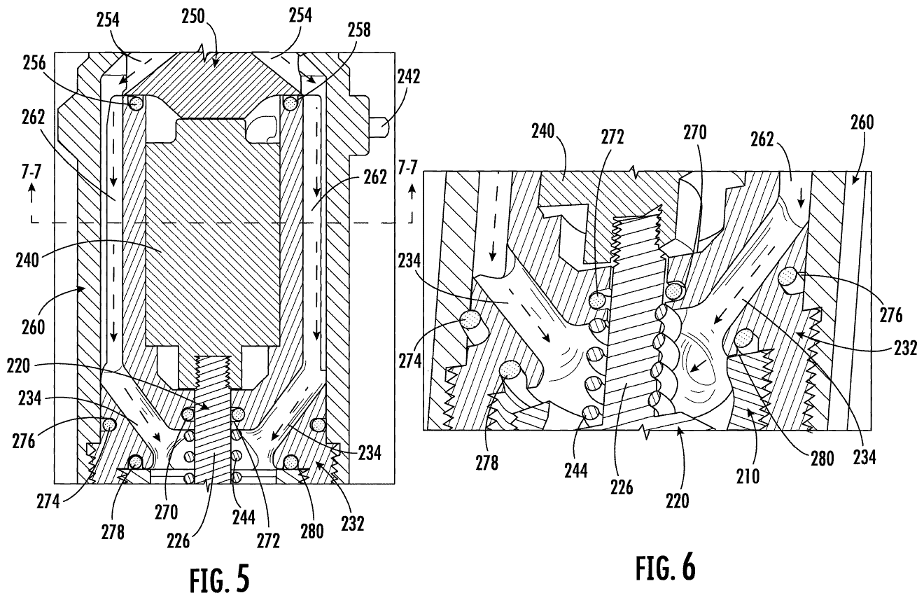

The injection housing 210 is disposed at least partially within the inner housing 232. As illustrated in FIGS. 5, 6, 8, and 9, the inner housing 232 defines a plurality of downstream channels 234 that are upstream of the cavity 214 (e.g., pre-charge chamber, etc.) of the injection housing 210. The downstream channels 234 are configured to provide the fuel to the cavity 214. The injection body 220 is slidably coupled to the inner housing 232. The injection housing 210, the injection body 220, and/or the inner housing 232 can be formed of or otherwise include a metal alloy, such as stainless steel. Stainless steel is environmentally friendly and can be inert to certain fuels, such as hydrogen. In some embodiments, each of the injection housing 210, the injection body 220, and the inner housing 232 is formed of or otherwise includes a metal alloy, such as stainless steel.

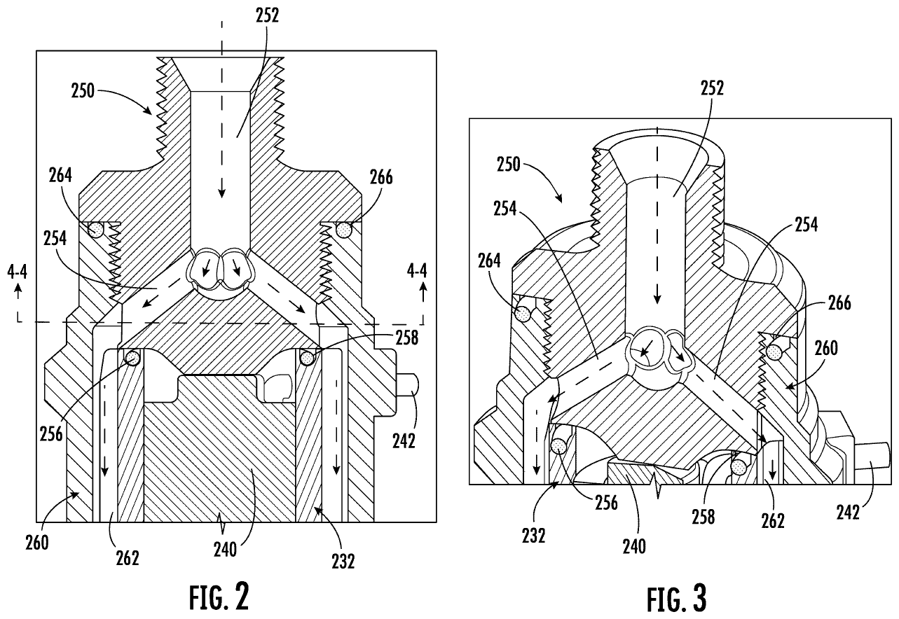

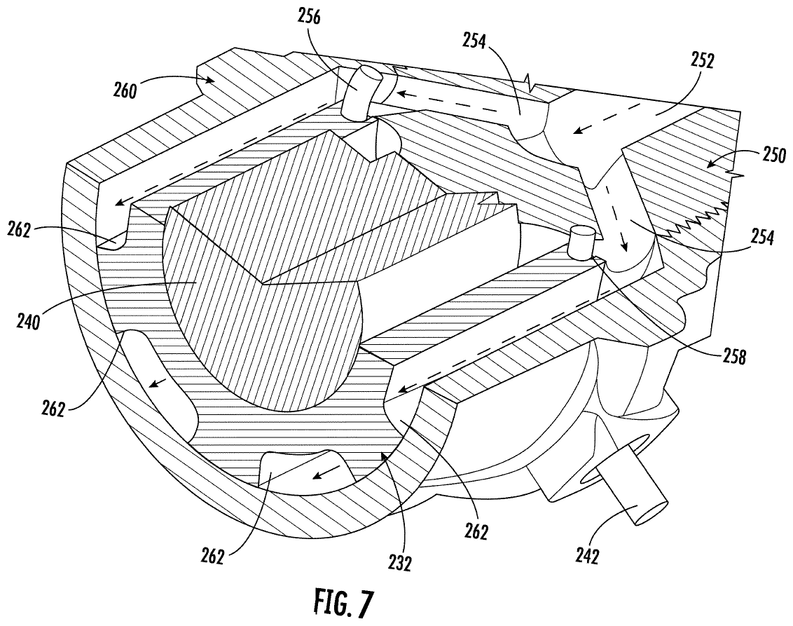

As illustrated in FIGS. 1-3 and 5-7, the fuel injector 100 can include a solenoid 240. The solenoid 240 can be disposed within the inner housing 232. The solenoid 240 is coupled to the extension member 226 and is configured to translate the injection body 220 in the axial direction via the extension member 226. In some embodiments, the solenoid 240 is coupled to the extension member 226 via interfacing threads, thereby simplifying a disassembly process between the solenoid 240 and the extension member 226 for maintenance or component replacements. In other embodiments, the solenoid 240 is coupled to the extension member 226 via welding, adhesive, fasteners, or the like.

The solenoid 240 is operable, via a controller 241 (discussed in further detail below), between a first state and a second state. The first state corresponds to a closed position of the injection body 220 where the plunger sealing surface 224 is in confronting relation with the housing sealing surface 212. At the first state, the cavity 214 is configured to receive fuel from the downstream channels 234 and retain the fuel. The second state corresponds to an open position of the injection body 220 where the plunger sealing surface 224 is positioned distal from the housing sealing surface 212. At the second state, the cavity 214 is configured to release the retained fuel.

In some embodiments, the solenoid 240 is operable, via the controller 241, between a plurality of substates between the first state and the second state. Each of the substates corresponds to a unique partially open position of the injection body 220 where the plunger sealing surface 224 is positioned distal from the housing sealing surface 212 at a unique distance. In some embodiments, the first state is an off state of the solenoid 240 (i.e., the solenoid 240 is not electrically charged, etc.) and the second state is an on state of the solenoid 240 (i.e., the solenoid 240 is electrically charged, etc.). In other embodiments, the first state is an on state of the solenoid 240 and the second state is an off state of the solenoid 240.

An engine system that includes the fuel injector 100 includes the controller 241. The controller 241 is electrically or communicatively coupled to the solenoid 240 via a wire 242 of the solenoid 240. The controller 241 is configured to control a state of the solenoid 240 (i.e., select between the first state, the second state, a state of the plurality of substates, etc.).

The controller 241 includes a processing circuit. The processing circuit includes a processor and a memory. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing a processor, ASIC, FPGA, etc. with program instructions. This memory can include a memory chip, Electrically Erasable Programmable Read-Only Memory (EEPROM), Erasable Programmable Read Only Memory (EPROM), flash memory, or any other suitable memory from which the controller 241 can read instructions. The instructions can include code from any suitable programming language. The memory can include various modules that include instructions which are configured to be implemented by the processor.

In various embodiments, the controller 241 is configured to communicate with a central controller (e.g., engine control unit (ECU), engine control module (ECM), etc.) of the engine system. In some embodiments, the central controller and the controller 241 are integrated into a single controller.

In some embodiments, the central controller is communicable with a display device (e.g., screen, monitor, touch screen, heads up display (HUD), indicator light, etc.). The display device can be configured to change state in response to receiving information from the central controller and/or the controller 241. For example, the display device can be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller and/or the controller 241. By changing state, the display device can provide an indication to a user (e.g., operator, etc.) of a status (e.g., operation, in need of service, etc.) of the engine system and/or the fuel injector 100.

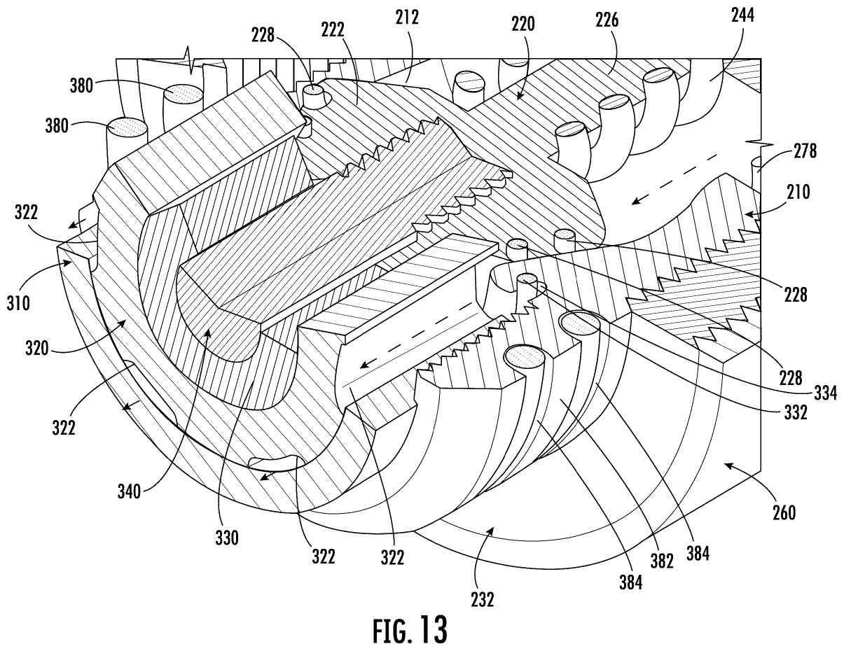

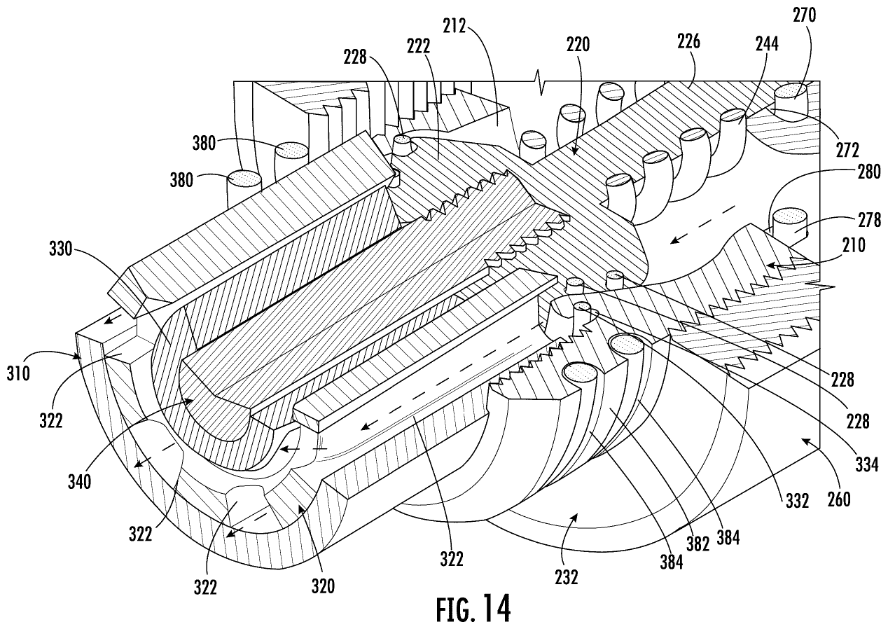

As illustrated in FIGS. 5, 6, 8-10, 13, and 14, the injection assembly 200 can include a biasing member 244 (e.g., a spring, etc.) disposed circumferentially around at least a portion of the extension member 226. The biasing member 244 can be disposed between the plunger 222 and the inner housing 232. The biasing member 244 is configured to apply a force to the plunger 222 in a direction away from the inner housing 232, such that, when the solenoid 240 is in the first state, the plunger sealing surface 224 of the plunger 222 is encouraged to be in confronting relation with the housing sealing surface 212. The biasing member 244 can be formed of or otherwise include a metal alloy, such as stainless steel.

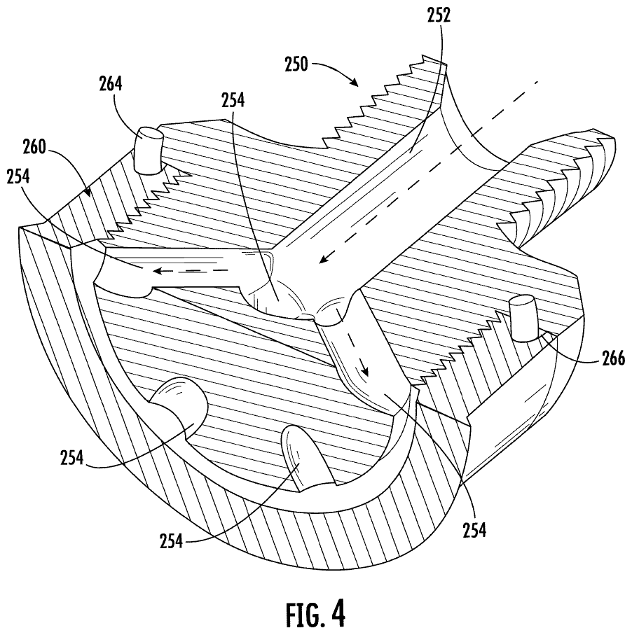

As illustrated in FIGS. 1-5 and 7, the fuel injector 100 can include an upper housing 250. The upper housing 250 can be coupled to the inner housing 232 via interfacing threads, welding, adhesive, fasteners, or the like. The upper housing 250 can be formed of or otherwise include a metal alloy, such as stainless steel.

The upper housing 250 includes a main channel 252 that is upstream of the downstream channels 234 of the inner housing 232 and is configured to receive the fuel from a fuel source (e.g., a fuel line, a fuel tank, etc.). The upper housing 250 also includes a plurality of sub channels 254 that are downstream of the main channel 252 and upstream of the downstream channels 234 of the inner housing 232. Each of the sub channels 254 is configured to receive the fuel from the main channel 252 and/or the fuel source.

As illustrated in FIGS. 2, 3, 5, and 7, the fuel injector 100 can include an inner housing sealing member 256 in engagement with the inner housing 232 and the upper housing 250. The inner housing sealing member 256 is configured to create a fuel-tight seal between the inner housing 232 and the upper housing 250 to prevent or minimize transfer of fluid between the inner housing 232 and the upper housing 250 to outside of the fluid channels (e.g., the sub channels 254, etc.).

The inner housing 232 can define a groove 258 proximate the upper housing 250. The inner housing sealing member 256 can be disposed within the groove 258 of the inner housing 232. The inner housing sealing member 256 can be formed of or otherwise include a polymer. In some embodiments, the inner housing sealing member 256 is formed of or otherwise includes a polymer that has a relatively high heat tolerance. For example, the inner housing sealing member 256 can be formed of or otherwise include a polymer that has a higher heat tolerance than nitrile rubber, such as PEEK. The inner housing sealing member 256 can include an O-ring. The fuel injector 100 can include a plurality of the inner housing sealing member 256 and the groove 258, where each of the inner housing sealing members 256 corresponds to each of the grooves 258. For example, the fuel injector 100 can include two, three, six, etc. of the inner housing sealing member 256 and the groove 258.

As illustrated in FIGS. 1-10, the fuel injector 100 can include an outer housing 260. The outer housing 260 can be coupled to the inner housing 232. In some embodiments, the outer housing 260 is coupled to the inner housing 232 via interfacing threads, thereby simplifying a disassembly process between the outer housing 260 and the inner housing 232 for maintenance or component replacements. In other embodiments, the outer housing 260 is coupled to the inner housing 232 via welding, adhesive, fasteners, or the like. The inner housing 232 can be disposed at least partially within the outer housing 260. The outer housing 260 can be formed of or otherwise include a metal alloy, such as stainless steel. The inner housing 232 and the outer housing 260 define a plurality of upstream channels 262 that are upstream of the downstream channels 234 of the inner housing 232.

In some embodiments, a number of the upstream channels 262 is equal to a number of the downstream channels 234, such that flow of the fuel is streamlined (i.e., a relatively smoother flow path is disposed) between the upstream channels 262 and the downstream channels 234, thereby reducing backpressure of the fuel within the fuel injector 100. In other embodiments, the number of the upstream channels 262 is not equal to the number of the downstream channels 234. For example, the number of the upstream channels 262 can be greater than the number of the downstream channels 234. As another example, the number of the upstream channels 262 can be less than the number of the downstream channels 234.

The outer housing 260 can be coupled to the upper housing 250. In some embodiments, the outer housing 260 is coupled to the upper housing 250 via interfacing threads, thereby simplifying a disassembly process between the outer housing 260 and the upper housing 250 for maintenance or component replacements. In other embodiments, the outer housing 260 is coupled to the upper housing 250 via welding, adhesive, fasteners, or the like. The upper housing 250 can be disposed at least partially within the outer housing 260. Each of the sub channels 254 of the upper housing 250 is disposed upstream of a corresponding one of the upstream channels 262. The outer housing 260 can couple the inner housing 232 and the upper housing 250. The outer housing 260 can couple the solenoid 240 to the inner housing 232 and the upper housing 250, such that the solenoid 240 is secured between the inner housing 232 and the upper housing 250.

As illustrated in FIGS. 2-4, the fuel injector 100 can include an outer housing scaling member 264. The outer housing sealing member 264 is in engagement with the outer housing 260 and the upper housing 250. The outer housing sealing member 264 is configured to create a fuel-tight seal between the outer housing 260 and the upper housing 250 to prevent or minimize transfer of fluid between the outer housing 260 and the upper housing 250 to outside of the fluid channels (e.g., the main channel 252, the sub channels 254, the upstream channels 262, etc.).

The outer housing 260 can define a groove 266 proximate the upper housing 250. The outer housing sealing member 264 is disposed within the groove 266 of the outer housing 260. The outer housing sealing member 264 can be formed of or otherwise include a polymer, such as PEEK. The outer housing sealing member 264 can include an O-ring. The fuel injector 100 can include a plurality of the outer housing sealing member 264 and the groove 266, where each of the outer housing sealing members 264 corresponds to each of the grooves 266. For example, the fuel injector 100 can include two, three, six, etc. of the outer housing sealing member 264 and the groove 266.

As illustrated in FIGS. 5, 6, 8, 10, and 14, the fuel injector 100 includes a first sealing member 270. The first sealing member 270 can be in engagement with the inner housing 232 and the extension member 226. The first sealing member 270 is configured to create a fuel-tight seal between the inner housing 232 and the extension member 226 to prevent or minimize transfer of fluid between the inner housing 232 and the extension member 226 to outside of the fluid channels (e.g., the downstream channels 234, the cavity 214, etc.).

The first sealing member 270 can be formed of or otherwise include a polymer, such as nitrile rubber. The first sealing member 270 can include an O-ring. The inner housing 232 can define a first groove 272 proximate the extension member 226. The first sealing member 270 can be disposed within the first groove 272. The fuel injector 100 can include a plurality of the first sealing member 270 and the first groove 272, where each of the first sealing members 270 corresponds to each of the first grooves 272. For example, the fuel injector 100 can include two, three, six, etc. of the first sealing member 270 and the first groove 272.

As illustrated in FIGS. 5, 6, and 8-10, the fuel injector 100 includes a second sealing member 274. The second sealing member 274 can be in engagement with the inner housing 232 and the outer housing 260. The second sealing member 274 is configured to create a fuel-tight seal between the inner housing 232 and the outer housing 260 to prevent or minimize transfer of fluid between the inner housing 232 and the outer housing 260 to outside of the fluid channels (e.g., the upstream channels 262, the downstream channels 234, the cavity 214, etc.).

The second sealing member 274 can be formed of or otherwise include a polymer, such as PEEK. The second sealing member 274 can include an O-ring. The inner housing 232 can define a second groove 276 proximate the outer housing 260. The second sealing member 274 can be disposed within the second groove 276. The fuel injector 100 can include a plurality of the second sealing member 274 and the second groove 276, where each of the second sealing members 274 corresponds to each of the second grooves 276. For example, the fuel injector 100 can include two, three, six, etc. of the second sealing member 274 and the second groove 276.

As illustrated in FIGS. 5, 6, 8, 9, 13, and 14, the fuel injector 100 includes a third sealing member 278. The third sealing member 278 can be in engagement with the inner housing 232 and the injection housing 210. The third sealing member 278 is configured to create a fuel-tight seal between the inner housing 232 and the injection housing 210 to prevent or minimize transfer of fluid between the inner housing 232 and the injection housing 210 to outside of the fluid channels (e.g., the downstream channels 234, the cavity 214, etc.).

The third sealing member 278 can be formed of or otherwise include a polymer, such as PEEK. The third sealing member 278 can include an O-ring. The inner housing 232 can define a third groove 280 proximate the injection housing 210. The third sealing member 278 can be disposed within the third groove 280. The fuel injector 100 can include a plurality of the third sealing member 278 and the third groove 280, where each of the third sealing members 278 corresponds to each of the third grooves 280. For example, the fuel injector 100 can include two, three, six, etc. of the third sealing member 278 and the third groove 280.

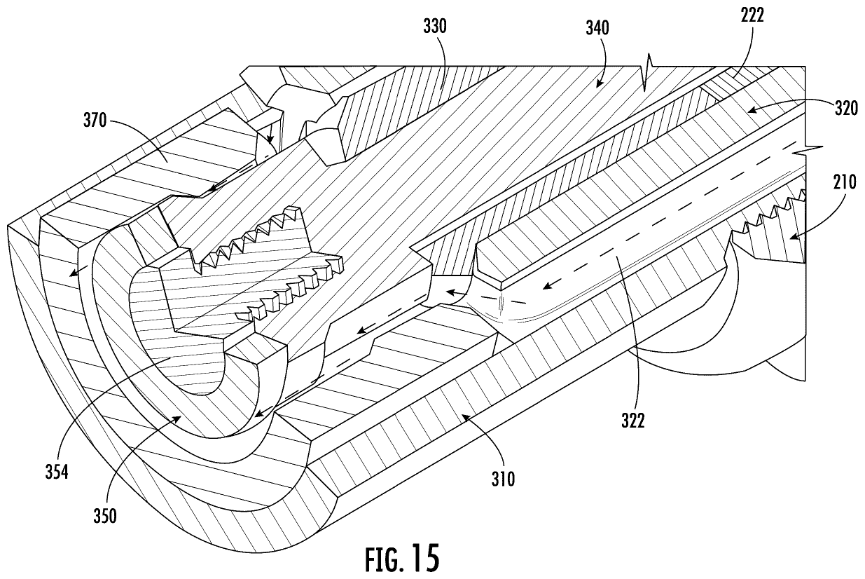

As illustrated in FIGS. 1 and 11-15, the fuel injector 100 can include a bearing assembly 300. The bearing assembly 300 for the fuel injector 100 comprises a bearing housing 310 and an outer bearing 320 coupled to and disposed within the bearing housing 310. The outer bearing 320 and the bearing housing 310 defining a plurality of bearing channels 322 configured to receive fuel. The bearing assembly 300 further comprises an inner bearing 330 disposed at least partially within the outer bearing 320 and slidably coupled to the outer bearing 320, and a support shaft 340 coupled to the inner bearing 330. The support shaft 340 is configured to translate in an axial direction.

The bearing housing 310 can be coupled to the outer bearing 320 via interfacing threads, welding, adhesive, fasteners, or the like. The outer bearing 320 and/or the inner bearing 330 can be formed of or otherwise include a ceramic material, such as silicon nitride or silicon carbon nitride. The ceramic material can be resistant to high temperatures (e.g., temperatures associated with fuel combustion, temperatures of up to about 2000 degrees C., etc.), requires no lubrication (i.e., removes need for an oiling system for fuel injector lubrication), has good wear properties, and is environmentally friendly. In some embodiments, each of the outer bearing 320 and the inner bearing 330 is formed of or otherwise includes a ceramic material, such as silicon nitride or silicon carbon nitride.

As illustrated in FIGS. 8, 9, and 11-14, the fuel injector 100 can include a first injection housing sealing member 332. The first injection housing sealing member 332 can be in engagement with the injection housing 210 and the bearing housing 310. The first injection housing sealing member 332 is configured to create a fuel-tight seal between the injection housing 210 and the bearing housing 310 to prevent or minimize transfer of fluid between the injection housing 210 and the bearing housing 310 to outside of the fluid channels (e.g., the cavity 214, the bearing channels 322, etc.).

The first injection housing sealing member 332 can be formed of or otherwise include a polymer, such as PEEK. The first injection housing sealing member 332 can include an O-ring. The injection housing 210 can define a first groove 334 proximate the bearing housing 310. The first injection housing sealing member 332 can be disposed within the first groove 334. The fuel injector 100 can include a plurality of the first injection housing sealing member 332 and the first groove 334, where each of the first injection housing sealing members 332 corresponds to each of the first grooves 334. For example, the fuel injector 100 can include two, three, six, etc. of the first injection housing sealing member 332 and the first groove 334.

As illustrated in FIGS. 1, 8, 9, and 11-15, the support shaft 340 can be coupled to the inner bearing 330 and the plunger 222. In some embodiments, the support shaft 340 is coupled to the plunger 222 via interfacing threads, thereby simplifying a disassembly process between the support shaft 340 and the plunger 222 for maintenance or component replacements. In other embodiments, the support shaft 340 is coupled to the plunger 222 via welding, adhesive, fasteners, or the like. The bearing housing 310 and/or the support shaft 340 can be formed of or otherwise include a metal alloy, such as stainless steel. In some embodiments, each of the bearing housing 310 and the support shaft 340 is formed of or otherwise includes a metal alloy, such as stainless steel.

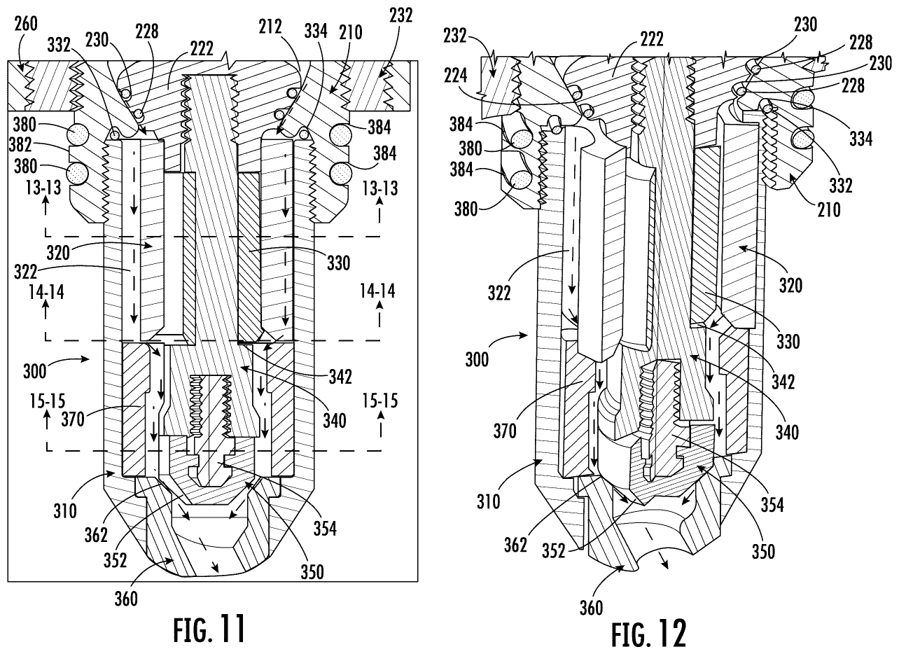

The support shaft 340 is configured to translate in the axial direction. In some embodiments, the support shaft 340 translates in the axial direction based on movement of the plunger 222 in the axial direction. As illustrated in FIGS. 11 and 12, the support shaft 340 includes a shoulder portion 342 configured to receive at least a portion of a surface of the inner bearing 330. The inner bearing 330 can be disposed along the support shaft 340 between the shoulder portion 342 and the plunger 222, such that the inner bearing 330 is secured between the shoulder portion 342 and the plunger 222.

As illustrated in FIGS. 1, 11, 12, and 15, the fuel injector 100 can include a cap 350 (e.g., a flame shield, etc.) coupled to the support shaft 340. The cap 350 includes a cap sealing surface 352. In some embodiments, the cap 350 is coupled to the support shaft 340 via interfacing threads, thereby simplifying a disassembly process between the cap 350 and the support shaft 340 for maintenance or component replacements. In other embodiments, the cap 350 is coupled to the support shaft 340 via welding, adhesive, fasteners, or the like. The cap 350 can be formed of or otherwise include a ceramic material, such as silicon nitride or silicon carbon nitride. In some embodiments, the cap 350 is formed of or otherwise includes compression molded silicon nitride.

As illustrated in FIGS. 11, 12, and 15, the fuel injector 100 can include an insert 354 that is coupled to the cap 350 to the support shaft 340 and is configured to couple the cap 350 to the support shaft 340. In some embodiments, the insert 354 is coupled to the support shaft 340 and/or the cap 350 via interfacing threads, thereby simplifying a disassembly process between the insert 354, the support shaft 340, and the cap 350 for maintenance or component replacements. In other embodiments, the insert 354 is coupled to the support shaft 340 and/or the cap 350 via welding, adhesive, fasteners, or the like. In some embodiments, the insert 354 is coupled to the cap 350 by being casted within the cap 350 or by the cap 350 being casted around the insert 354, and the insert 354 is coupled to the support shaft 340 via interfacing threads. The insert 354 can be formed of or otherwise include a metal alloy, such as stainless steel.

As illustrated in FIGS. 1, 11 and 12, the fuel injector 100 can include a tip 360 coupled to the bearing housing 310 and disposed at least partially within the bearing housing 310. The tip 360 is disposed downstream of the bearing channels 322 and downstream of the support shaft 340. The tip 360 includes a tip sealing surface 362 that is configured to interface with the cap sealing surface 352 to create a flame-tight seal. The flame-tight seal prevents or minimizes flame from the combustion chamber of the engine, which is downstream of the tip 360, from moving upstream into the fuel injector 100 through the interface between the tip sealing surface 362 and the cap sealing surface 352. The tip 360 can be formed of or otherwise include a ceramic material, such as silicon nitride or silicon carbon nitride.

In some embodiments, the interface between the tip sealing surface 362 and the cap sealing surface 352 does not form a fuel-tight seal. In these embodiments, the interface between the plunger sealing surface 224 and the housing sealing surface 212 forms the fuel-tight seal that allows for accumulation of fuel before injection, which is upstream of the interface between the tip sealing surface 362 and the cap sealing surface 352 and farther from the combustion chamber of the engine, thereby reducing wear and tear to the fuel-tight seal that can be caused by relatively high fuel combustion temperatures.

As illustrated in FIGS. 1, 11, 12, and 15, the fuel injector 100 can include a spacer 370. The spacer 370 is coupled to the outer bearing 320, the bearing housing 310, and the tip 360. The spacer 370 is disposed within the bearing housing 310, downstream of the outer bearing 320, and upstream of the tip 360. The spacer 370 can be positioned radially distal from the support shaft 340, such that the spacer 370 does not block the fuel flowing from the bearing channels 322 to the tip 360 when the solenoid 240 is at the second state. In some embodiments, the spacer 370 can be formed of or otherwise include a metal alloy, such as stainless steel. In other embodiments, the spacer 370 can be formed of or otherwise include a ceramic material, such as silicon nitride or silicon carbon nitride. The outer bearing 320 can be disposed between the injection housing 210 and the spacer 370, such that the outer bearing 320 is secured between the injection housing 210 and the spacer 370.

When the solenoid 240 is controlled by the controller 241 to be at the second state, the cavity 214 is configured to release the fuel retained from the first state. The released fuel travels from the cavity 214, through the bearing channels 322, the spacer 370, and the tip 360 to reach the intake manifold and/or the combustion chamber of the engine.

As illustrated in FIGS. 8, 9, 11, 12, 13, and 14, the fuel injector 100 can include a second injection housing sealing member 380. The second injection housing sealing member 380 can be in engagement with the injection housing 210 and a component of the engine system (e.g., a cylinder head, etc.). For example, the fuel injector 100 can be configured to be disposed within a bore of a cylinder head of the engine system, such that the second injection housing sealing member 380 is in engagement with the injection housing 210 and the cylinder head. The second injection housing sealing member 380 is configured to create a fuel-tight seal between the injection housing 210 and the component of the engine system to prevent or minimize transfer of fluid between the injection housing 210 and the component of the engine system to surrounding environments.

The second injection housing sealing member 380 can be formed of or otherwise include a polymer, such as PEEK. The second injection housing sealing member 380 can include an O-ring. The injection housing 210 includes an outer surface 382. The injection housing 210 can define a groove 384 on the outer surface 382. The second injection housing sealing member 380 can be disposed within the groove 384. The fuel injector 100 can include a plurality of the second injection housing sealing member 380 and the groove 384, where each of the second injection housing sealing members 380 corresponds to each of the grooves 384. For example, the fuel injector 100 can include two, three, six, etc. of the second injection housing sealing members 380 and the groove 384.

The plunger sealing member 228, the inner housing sealing member 256, the first sealing member 270, the third sealing member 278, and/or the first injection housing sealing member 332 can create a fuel-tight seal within an interior of the fuel injector 100. The outer housing sealing member 264, the second sealing member 274, and/or the second injection housing sealing member 380 can create a fuel-tight seal between the fuel injector 100 and an environment exterior to the fuel injector 100 (e.g., surrounding environment, ambient environment, other engine system components, etc.).

While this specification contains many specific implementation details, these should not be construed as limitations on the scope of what can be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features can be described as acting in certain combinations and even initially claimed as such, one or more features from a claimed combination can, in some cases, be excised from the combination, and the claimed combination can be directed to a subcombination or variation of a subcombination.

As utilized herein, “generally” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure.

The term “coupled” and the like, as used herein, mean the joining of two components directly or indirectly to one another. Such joining can be stationary (e.g., permanent) or moveable (e.g., removable or releasable). Such joining can be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features can be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. can be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. An injection assembly for a fuel injector, the injection assembly comprising:
an injection housing comprising a housing sealing surface defining a cavity configured to receive fuel; and
an injection body disposed at least partially within the injection housing, the injection body comprising:
a plunger comprising a plunger sealing surface configured to interface with the housing sealing surface to create a fuel-tight seal, and
an extension member coupled to the plunger, the extension member configured to translate the plunger in an axial direction; and
a plunger sealing member coupled to the plunger sealing surface, the plunger sealing member configured to engage with the housing sealing surface.

2. A fuel injector comprising:
the injection assembly of claim 1;
an inner housing coupled to the injection housing and defining a plurality of downstream channels upstream of the cavity, the injection housing disposed at least partially within the inner housing, the injection body slidably coupled to the inner housing; and
a solenoid disposed within the inner housing, the solenoid coupled to the extension member and configured to translate the injection body in the axial direction via the extension member.

3. The fuel injector of claim 2, further comprising an upper housing coupled to the inner housing, the upper housing defining:
a main channel upstream of the downstream channels and configured to receive the fuel from a fuel source; and
a plurality of sub channels downstream of the main channel and upstream of the downstream channels, each of the sub channels configured to receive the fuel from the main channel.

4. The fuel injector of claim 3, further comprising an inner housing sealing member in engagement with the inner housing and the upper housing, wherein the inner housing defines a groove proximate the upper housing, the inner housing sealing member disposed within the groove.

5. The fuel injector of claim 4, wherein:
the inner housing sealing member comprises polyetheretherketone; and
each of the inner housing, the injection body, and the injection housing comprise stainless steel.

6. The fuel injector of claim 4, wherein the inner housing sealing member comprises an O-ring.

7. The fuel injector of claim 2, further comprising an outer housing coupled to the inner housing, the inner housing disposed within the outer housing, the inner housing and the outer housing defining a plurality of upstream channels upstream of the downstream channels.

8. The fuel injector of claim 7, wherein a number of the upstream channels is equal to a number of the downstream channels.

9. The fuel injector of claim 7, further comprising:
an upper housing coupled to the inner housing and the outer housing, the upper housing defining a plurality of sub channels configured to receive the fuel from a fuel source, each of the sub channels disposed upstream of a corresponding upstream channel of the upstream channels; and
an outer housing sealing member in engagement with the outer housing and the upper housing, wherein the outer housing defines a groove proximate the upper housing, the outer housing sealing member disposed within the groove.

10. The fuel injector of claim 7, further comprising:
a first sealing member in engagement with the inner housing and the extension member, the first sealing member comprising nitrile;
a second sealing member in engagement with the inner housing and the outer housing, the second sealing member comprising polyetheretherketone; and
a third sealing member in engagement with the inner housing and the injection housing, the third sealing member comprising polyetheretherketone.

11. The fuel injector of claim 10, wherein the inner housing defines:
a first groove proximate the extension member, the first sealing member disposed within the first groove;
a second groove proximate the outer housing, the second sealing member disposed within the second groove; and
a third groove proximate the injection housing, the third sealing member disposed within the third groove.

12. The fuel injector of claim 2, wherein the solenoid is operable, via a controller, between a first state and a second state, the first state corresponding to a closed position of the injection body where the plunger sealing surface is in confronting relation with the housing sealing surface, and the second state corresponding to an open position of the injection body where the plunger sealing surface is positioned distal from the housing sealing surface.

13. The injection assembly of claim 1, further comprising a biasing member disposed circumferentially around at least a portion of the extension member.

14. The injection assembly of claim 1, wherein, the plunger sealing member comprises nitrile.

15. A fuel injector comprising:
the injection assembly of claim 1; and
a bearing assembly comprising:
a bearing housing,
an outer bearing coupled to and disposed within the bearing housing, the outer bearing and the bearing housing defining a plurality of bearing channels configured to receive fuel,
an inner bearing disposed at least partially within the outer bearing and slidably coupled to the outer bearing, and
a support shaft coupled to the inner bearing, the support shaft configured to translate in an axial direction.

16. The fuel injector of claim 15, further comprising:
a cap coupled to the support shaft, the cap comprising a cap sealing surface; and
a tip coupled to the bearing housing and disposed at least partially within the bearing housing, the tip disposed downstream of the bearing channels, the tip comprising a tip sealing surface configured to interface with the cap sealing surface to create a flame-tight seal.

17. The fuel injector of claim 16, further comprising an insert coupling the cap to the support shaft, the insert comprising a metal alloy.

18. The fuel injector of claim 16, wherein the interface between the tip sealing surface and the cap sealing surface does not form a fuel-tight seal.

19. The fuel injector of claim 16, further comprising a spacer coupled to the outer bearing, the bearing housing, and the tip, the spacer disposed within the bearing housing, downstream of the outer bearing, and upstream of the tip.

20. The fuel injector of claim 15, wherein:
each of the outer bearing and the inner bearing comprise one of silicon nitride or silicon carbon nitride; and
each of the support shaft and the bearing housing comprise stainless steel.
